(19) United States
(12) Patent Application Publication
(10) Pub. No.: US 2013/0157611 A1
(43) Pub. Date: Jun. 20, 2013

(54) MOBILE CELLULAR NODE METHOD AND APPARATUS FOR EMERGENCY RELIEF AND RESCUE

(71) Applicant: Eric Small, Monroe Township, NJ (US)

(72) Inventor: Eric Small, Monroe Township, NJ (US)

(21) Appl. No.: 13/330,926

(22) Filed: Dec. 20, 2011

(51) Int. Cl. H04W 4/16; H04W 4/02

(52) U.S. Cl. 455/404.2; 455/415

(57) ABSTRACT

A multimodal mobile cellular node for use by emergency workers and law-enforcement personnel is disclosed. When installed on a hook-and-ladder truck, the node is used to locate and communicate with persons trapped in a high-rise building by fire. When carried by an aircraft, the node provides a cone of coverage, enabling cellular communication and interoperability between handsets using different types CMRS signals in the event some part of the local cellular infrastructure fails. The node also produces a CMRS beacon enabling the node to communicate with handsets individually using the ID numbers provided by their ID signals and to map the handsets' location and movements, to guide emergency relief efforts. These mobile nodes can also improve traffic safety by identifying drivers who are using cellphones while driving.

### BACKGROUND OF THE INVENTION

1. Field of the Invention

The invention relates to Commercial Mobile Radio Services (CMRS) networks. More particularly, the invention relates to CMRS handset operations. As used herein, the word “cellular” refers to CMRS systems generally, including but not limited to TDMA, CDMA, and GSM communications systems and the “handsets” discussed may be any of the many suitable types of handheld devices that can use CMRS communication systems, including “tablets” and “smart phones” of every variety, and many other handheld CRMS devices yet to come.

2. Discussion of Related Art

Wireless communications networks are, in many ways, more robust than our legacy “copper wire” communications infrastructure. Wind, heat, ice and snow all conspire to keep linemen busy climbing poles to repair the wires. Of course urban rooftop cellular CRMS sites and their microwave and PSTN interconnect equipment are also physically vulnerable to fire, wind and flood.

Physical damage to cellular networks' antenna towers and the other cellular infrastructure in hurricane Katrina further delayed the restoration of cellular service, but that is only one of the failure modes that affect cellular networks. As the East Coast blackout of August 2003 reminded us, once a network's backup power sources fail, the synchronization of its entire infrastructure fails and, therefore, because the network will have to be re-initiated, it is likely to remain out of service for a protracted length of time even where there is no structural damage.

Acceptable urban cellular CMRS signal coverage requires a large number of cellular transceiver sites for each CMRS network because of urban signal interference and obstruction—many more sites than most people realize. Thus an attempt to replace spent power packs for even one such network is likely to still be in progress long after power supplied to it from the power grid is restored. Those power packs, which may be batteries, fuel cells or even catalytic thermopiles, will be recharged or replaced once line power is restored, rather than trying to replace them all while the power lines are still out of service.

After about four hours without line power, a cellular network's backup power sources are exhausted and the network itself goes down. Then, in addition to repairing any structural damage, interconnects between cellular sites and interconnects to the Public Switched Telephone Network (PSTN) will have to be re-initiated before cellular service is restored. The resulting prolonged blackout of cellular communications hinders emergency evacuation, rescue and relief efforts.

The use of modified cellular handsets to create a peer-to-peer mesh network between the handsets when conventional infrastructure fails is discussed at: http://gigaom.com/mobile/egypt-as-example-a-case-for-mesh-networks-on-phones/ Specialized mesh network handsets that use what is called ZigBee™ technology were distributed to the New Orleans police after hurricane Katrina wiped out their wireless communications infrastructure. However, even the modified cellular handsets need repeaters to communicate with someone more than a few kilometers away, and, these GIGAom/ZigBee cellular handsets are special-purpose handsets, not the ones that people were carrying when hurricane Katrina struck the Gulf Coast. Up to now, those conventional cellular handsets that most people carry have not been useable for emergency communications in power blackouts or large scale search and rescue work.

However, conventional cellular handsets are better suited for emergency use because most people carry them every day Also, like little emergency beacons, these cellular handsets will automatically repeatedly transmit a signal long after the local cellular network has failed and conventional cellular telephone calls are no longer possible. They can also be easily charged by solar cells, even powered by an otherwise “dead” automobile battery, if necessary. However, up to now, the local cellular infrastructure had to be used to call or receive a call from a cellular handset, and the telephone number of a handset was needed to either call or receive data from it, and even to determine the geographical location of the cellular handset.

Portable cellular nodes are known. For sporting events and news events—during the President's visits to Martha's Vineyard, for example—the capacity of a local cellular network is increased by connecting portable “temporary” nodes to the existing telephone system, over T1 cables or microwave links that connect these temporary nodes to the existing cellular system to complete these additional calls. This temporarily enables more local subscribers to use the existing telephone system. However, these portable nodes also use telephone numbers for making calls and obtaining data, and the telephone numbers of the private citizens' cellular handsets are usually not available in emergency situations. Thus, their potential for emergency communications has not been realized.

Similarly, the location of a private citizen's conventional cellular handset has usually been determined either by using the handset's telephone number to query the cellphone's GPS data if that handset is GPS-enabled, or by triangulation, as is well known. Triangulation uses the horizontal bearing of any signals that are identified as being transmitted by a cellular handset having a particular telephone number, relative to multiple cellular transceivers in one or more cellular transceiver array locations 12a, 12b. However, both of these methods require the use of the handset's telephone number, and neither bearing information nor GPS coordinates can determine the location of these conventional cellular handsets within high-rise buildings. Furthermore, not only do both of these methods use the handset's telephone number, both are require the use of the particular part of a particular local cellular service provider's network that is used by that particular handset. That telephone number and even that provider's network may not be available in an emergency.

The shocking collapse of the World Trade Center towers on Sep. 11, 2001 made the world acutely aware of how important it is to rapidly locate and communicate with people at risk in high-rise building emergencies, both for their own safety and for the safety of the workers who are attempting to rescue them. Many firefighters were lost searching for people who were injured, or trapped by smoke and flames. Losses were also attributable, in part, to a lack of interoperability among the different types of communications equipment in use that day. In theory, since cellular handsets are ubiquitous and highly portable, people in a high-rise building could be quickly located, and also contacted, using their own cellular handsets, but the local cellular infrastructure quickly becomes overloaded and the telephone numbers of cellular handsets in the building is not known to the emergency workers. Cellular handsets also have many different carrier frequency and data format standards, making interoperability also a problem for the emergency use of these cellular handsets.

Three-dimensional RF direction finders are used for inventory control, and several of these are described in “Survey of Wireless Indoor Positioning techniques” IEEE Transactions on Systems, Man and Cybernetics—Part C: Applications and Reviews, Vol. 37, No. 6, November 2007. However, unlike these remote-positioning RF sensor devices that are designed for asset and inventory protection, a direction finder that locates a cellular handset must locate a short burst signal that is designed for conserving battery power, not ease of location—idle cellular handsets' signals are transmitted in short bursts that may occur only once every several minutes when a call is not in progress. The Rhode & Schwartz model #DDF 05A and an “RDF” brand device, model #DFP 1000B, are examples of devices that can use GSM and other types of CMRS burst signal standards for one-dimensional direction finding.

In accordance with the invention, targeted cellular handsets can be directly contacted by emergency workers without using a conventional telephone number, and also located and tracked, using the signals these handsets conventionally transmit.

### SUMMARY OF THE INVENTION

A mobile cellular node handset system in accordance with the invention includes a mobile CMRS transceiver that detects multiple types of CMRS signals produced by CMRS handsets and extracts ID signal data from the CMRS ID signals transmitted by those handsets. The ID signal data is distinctive of the cellular handset that transmitted it. A protocol computer connected to the transceiver stores the extracted ID signal data and compares it to ID signal data that was previously stored by the protocol computer to determine whether the cellular handset is a handset that transmitted another CMRS signal having stored ID signal data.

In one particular embodiment the transceiver transmits a first beacon signal having a given CMRS type and a first nominal location ID and transmits a second beacon signal of the same CMRS type having a second nominal location ID that is different from the first nominal location ID to receive first and second responses from a given handset. In another particular embodiment the transceiver supplies data to the protocol computer indicating the CMRS signal type of the ID signal from which the ID signal data was extracted, which stores the CMRS signal type data.

Preferably, the ID signal includes an ID number and the protocol computer uses the ID number to initiate a CMRS location query and to store handset location data extracted from a CMRS location signal transmitted in response to said query, said location data indicating the location of the handset. In a particular embodiment the protocol computer maps the location data. In a further embodiment, the protocol computer detects and maps changes in stored location data indicating the location of said handset over time. Alternatively, an airborne node determines location data by storing ID location data for the ID signal data that is stored for each handset during each iteration of a the search pattern that indicates where the aircraft was in a location-data defined search pattern when the airborne node received the ID signal data from the handset.

In another particular embodiment, the ID signal data includes an ID number of the cellular handset that the protocol computer uses to initiate a call to the cellular handset. Alternatively, the protocol computer uses the ID number to enable the cellular handset to initiate a call. In a further alternative, the signal protocol computer uses the ID number to provide interoperability for said first handset by enabling it to initiate a call through a second mobile transceiver to a second handset transmitting a signal having a different signal type.

In a further embodiment of the mobile cellular node, an RF data link is connected to the protocol computer, which uses the RF data link to increase the node's call handling capacity by delegating calls initiated by the protocol computer to an airborne mobile cellular node.

### BRIEF DESCRIPTION OF THE FIGURES

The invention will be better understood when the detailed description of presently preferred embodiments provided below is considered in conjunction with the figures provided herewith, in which:

FIG. 1 is a diagram showing an area affected by a cellular telephone infrastructure failure and the coverage area of an airborne cellular node that provides emergency cellular communications in accordance with the present invention;

FIG. 2 is a schematic block diagram of an airborne cellular node in accordance with the present invention that is deployable on the aircraft shown in FIG. 1;

FIG. 3 is a schematic block diagram of a multi-standard high-rise rescue locator node in accordance with the present invention;

FIG. 4a is a flow chart of steps implementing emergency operations in accordance with the present invention in the event cellular infrastructure fails;

FIG. 4b is a flow chart of steps implementing a high-rise rescue using the emergency locator node shown in FIG. 3, with the airborne cellular node shown in FIGS. 1 and 2 providing optional communications support.

In these figures similar structures have similar index numbers.

### DETAILED DESCRIPTION OF PREFERRED EMBODIMENTS OF THE INVENTION

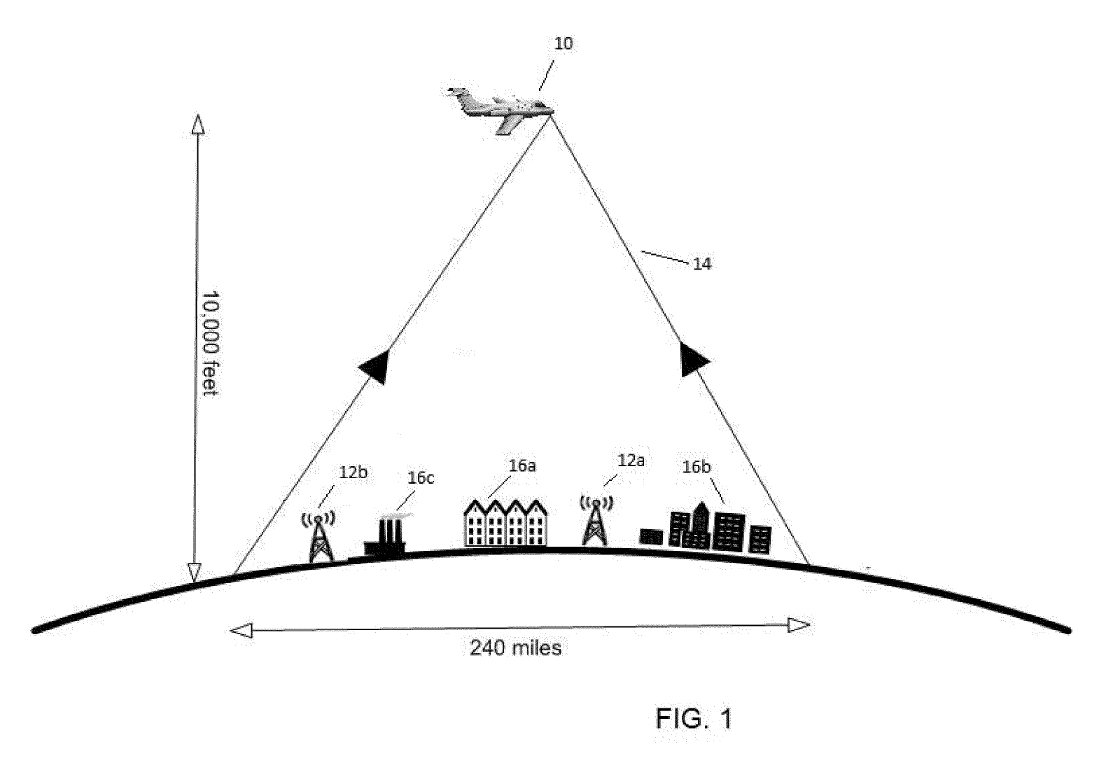

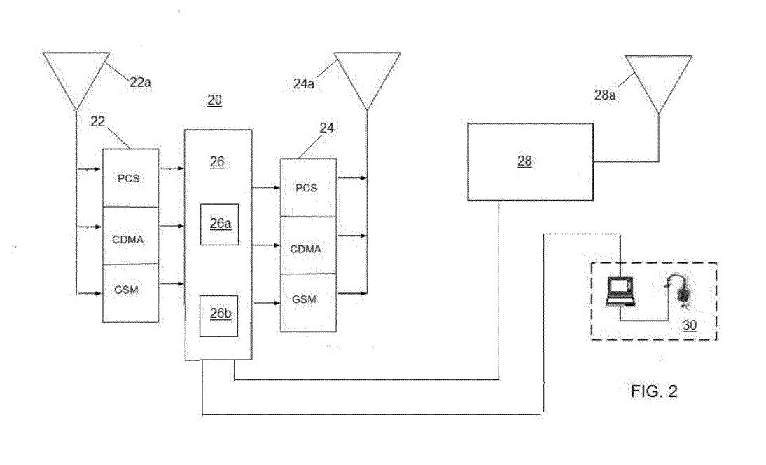

In accordance with the invention, the aircraft 10 shown in FIG. 1 carries a mobile cellular telephone node 20 shown in FIG. 2. This airborne node 20 has cone of coverage 14 within which it can communicate with and provide interoperability for cellular handsets without knowing the handsets' telephone numbers, and even when the local cellular infrastructure has failed. The cone of coverage 14 shown in FIG. 1 includes high-rise apartments 16a, high-rise businesses 16b and conventional stationary cellular nodes 12a, 12b. For the sake of convenience, the mobile node 20 may be bolted to hard points (not shown) that are conventionally provided on the external surface of airplanes' wings and fuselages, and also electrically connected to conventional workstation and/or down-link facilities that are carried inside the aircraft 10. Thus the airborne mobile nodes 20 can be conveniently detached from aircraft 10 when not in use. Alternatively, the airborne nodes 20 can be carried by an aerial balloon or the aircraft 10 may be a remote-controlled drone. These mobile nodes may be also carried by land vehicles to implement traffic safety and high-rise search and rescue applications.

At 10,000 feet the cone of coverage for an airborne mobile node 10 is 240 miles wide on the ground. Despite the low signal power produced by conventional cellular handsets, even an aircraft at 41,000 feet is potentially able to detect and communicate with a cellular handset that is within a 290 mile radius of an airborne node's vertically projected geographic location on the earth's surface, so long as the airborne node 10 has line-of-sight access to the handset's signal, because free-space signal loss at the frequencies used by conventional cellular handsets is very small. Lower altitudes decrease the maximum radius provided by the cone of coverage, but increase the robustness of the handset's link to the airborne cellular node. The 10,000 foot altitude shown in FIG. 1 provides a much more robust link with the hand set, and only slightly reduces the maximum coverage radius that is provided at 41,000 feet.

Identification (ID) signals are usually automatically produced by cellular handsets as long as they have a source of electrical power. The ID signals register each handset with a particular node of a local cellular network so that the handset can receive calls. The ID signals include the ID numbers that are used by cellular service providers to contact handsets and to block service to stolen cellular handsets: the International Mobile Equipment Identifier (IMEI) for GSM/UMTS handsets, and the MEID or ESN numbers of other types of handsets. If the cellular handset is idle, that is, if no one makes or receives a call using that cellular handset, an ID signal is normally transmitted by the handset as a brief burst signal every several minutes. If the handset receives no beacon signal from any suitable cellular node for an unusually long time, the handset's ID signal may be produced less frequently, but the handset still responds quickly to any beacon signal it receives from the next cellular node that has a suitable carrier frequency and signal format, as long as its battery provides power. While handsets remain idle, fully-charged conventional handset batteries will enable the handsets to transmit their ID signal for weeks. Because cellular handsets continue to transmit their ID signals long after the power packs that support cellular infrastructure are exhausted, the airborne mobile node 10 can provide not only ad-hoc interoperability for emergency workers, but also some backup for the cellular infrastructure that is used by the general public. In addition, especially now that GPS is becoming a standard feature of many handsets, after the local cellular infrastructure fails and triangulation data is no longer available to handsets in that area, the ID signals and GPS coordinates transmitted by GPS-enabled handsets can used by the airborne node 10 to map the location and movement of people in a disaster area, such as that left after hurricane Katrina.

Preferably, the mobile cellular node 20 shown in FIG. 2 has a first multi-mode transceiver 22 for incoming cellular communications, one or more additional multi-mode transceivers 24 for communicating with at least one additional handset, and respective wideband antennas 22a, 24a. A protocol computer 26 in the mobile node 20 stores ID signal data, handset location coordinates, and any other data that is detected and extracted by the transceivers 22, 24, from handset signals, such as data representing each handset's CMRS signal type carrier frequency and format. The protocol computer 26, also formats data that is sent to the handsets by the transceivers 22, 24. Preferably, at least one additional transceiver 24 is adapted to receive and transmit data using emergency signal frequencies and formats so that the airborne node can provide interoperability between emergency services handsets and cellular handsets, as well as between cellular handsets.

The protocol computer 26 is connected to an operator input device and an audio and video operator interface 30 that are either on the aircraft 10 or are connected to the corresponding ground-based unit of an RF data link transceiver 28 and antenna 28a installed on the aircraft 10. The protocol computer 26 also includes a codec 26a that enables authorized operators to decrypt and encrypt voice and data for CSMR signals transmitted to and received from cellular handsets and other cellular nodes, using the appropriate TDMA, CDMA or GSM format, carrier frequency and the encryption keycode, if any. A graphics unit 26b then maps and displays the location data that was stored by the protocol computer 26 on a terrain map in any suitable manner that is well-known in the art. Preferably, the terrain map also shows the ID number of each of the handsets and indicates any movement of the handsets that has been detected. Also, even after a mobile node 20 has extracted a handset's GSM hardware ID number, and can provide all types of data and voice communication between the mobile node 20, 40 and that handset, the codec 26a is still be needed to make voice and data signals between the handset and a local GSM cellular service provider's BTS node intelligible. The encryption keycodes (Kc) used by the BTSs are defined by the cellular service provider.

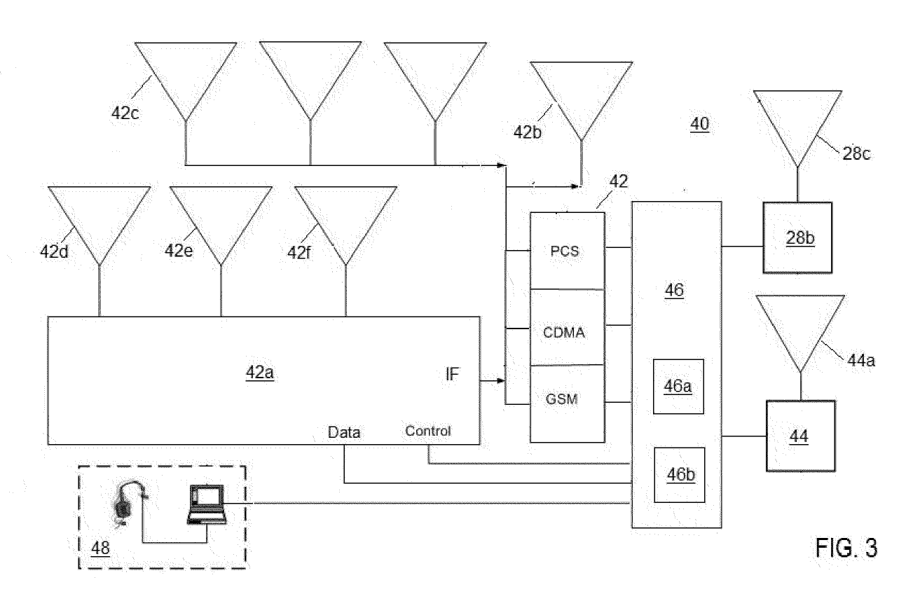

Furthermore, because mobile nodes in accordance with the invention can identify, locate and communicate with individual handsets without knowing the handset's telephone number, they can also be used by traffic safety officers and fire fighters to identify, locate and communicate with individual members of the public. For example, FIG. 3 shows an alternative configuration 40 of a mobile cellular node in accordance with the present invention, which is adapted for use by fire fighters as a high-rise rescue locator. To enable firefighters to locate and communicate with cellular handsets within a given high-rise building, the rescue locator 40 has a first multi-standard transceiver 42 for communicating with a target handset, and a second multi-standard transceiver 44 providing interoperability between two target handsets through the node 40. Each transceiver 42, 44 has a respective wideband antenna 42a, 44a. However, preferably, the rescue locator receiving antenna includes not only a three-dimensional direction finder 42a, but also a highly directional transmitting antenna 42b and a plurality of patch antennas 42c. The patch antennas 42c are distributed along the length of a hook-and-ladder truck to improve signal separation between the responses that are produced by handsets if the highly directional transmitting antenna 42b is used to transmit a beacon, so that as many of the ID signals of the responding handsets as possible can be extracted and stored by the protocol computer 46 for a single beacon transmission. The direction finder 42a is made up of three standard cellular RF direction-finder elements 42d-f: two azimuth elements 42d-e mounted at either end of the hook-and-ladder, and an elevation element 42f.

Like the airborne protocol computer 26, the rescue-locator protocol computer 46 formats data that is sent to the handsets by the transceivers 42, 44, and processes and stores each handset's ID signal data, CMRS carrier frequency and format, and any other voice and data information that is received and extracted by the transceivers 42, 44, from the handsets' signals. A codec 46a is also available to allow the mobile node to encrypt and decrypt data that is communicated with a target handset or with a conventional cellular node. For the rescue-locator node 40, the location data will include not only any GPS coordinates transmitted by the handsets, but also enhanced GPS (E-GPS) and triangulation data that is made available for each cellular handset by the cellular infrastructure.

However, GPS data is not reliable indoors and the triangulation data used by E-GPS to supplement GPS is, of course, only two-dimensional. Thus the rescue locator computer 46 computes the location coordinates of each target handset from data provided by three RF direction finder elements 42b-d and the protocol computer 46 also stores that location data. Like the airborne protocol computer 26, the rescue-locator protocol computer 46 includes an encoder 46a that decrypts and encrypts data for the transceivers 42, 44. The rescue-locator graphics unit 46b maps the location data stored by the protocol computer 46 on a wireframe display relative to the location of the direction-finder elements 42b-d, preferably using the GPS coordinates of the azimuth direction finder elements. The azimuth direction finder elements 42b-c are preferably mounted on opposite ends of a fire company's hook-and-ladder truck to maximize both the distance between them. Like the airborne node 20, the wireframe display provided by the rescue-locator node also preferably shows the ID number of each of the handsets and indicates movement of a handset when movement is detected.

The direction finder 42a of the rescue-locator node 40 outputs the content of the CMRS signal transmitted by the target cellular handset as an IF signal to the multi-standard transceiver 42. The transceiver 42 extracts the target handset's ID signal data and other data, and supplies that data to the protocol computer 46 which processes and stores them. In particular, the protocol computer 46 compares the ID signal and location data to stored ID and location data to determine whether that target has moved. The graphics unit 46b uses primarily direction-finder coordinates to map a handset's location data and indicate movement of each target handset when movement has been detected. If a target handset's ID number is known, using the CMRS carrier frequency and format used by the target handset, the operator 48 of the rescue locator mobile node 40 can also communicate through the target cellular handset with people in its vicinity. This enables rescue workers to not only determine the spatial coordinates of each target cellular handset and detect if it is moving, but to call it to obtain a report on the status of other people in that area and assist their evacuation, even though the handset's telephone number is not known. Preferably, the multimodal transceivers 42, 44 in the node also transmit and receive emergency services signal formats and frequencies, providing “ad hoc” interoperability not only between CMRS handsets, but also between the emergency workers' communications gear, and enabling nearby emergency workers to directly communicate with those awaiting rescue, without knowing any of the cellular handsets' telephone numbers and without regard to whether or not the cellular infrastructure supporting their handsets has failed.

The airborne node 20 and the locator node 40 can also be configured to use distinctive ID signal data extracted by their transceivers 22, 42 and stored by the computer 46, ID data that describes the ID signal transmitted by a handset, for tracking the handset, even if that handset's ID number cannot be extracted. Any signal parameters of an encrypted ID signal transmitted by a given handset that are sufficiently stable and distinctive of that given handset may still provide ID data that can be used to subsequently identify that handset as the source of a received signal for purpose of tracking a handset, even though that ID signal data does not enable voice and data communication to and from the handset. Preferably, however, the ID number of each handset is extracted and stored by the computers 26, 46, so that the mobile nodes 20, 40 can use those ID numbers to directly communicate with those individual handsets.

In addition to the transceivers 42, 44, the rescue-locator node 40 shown in FIG. 3 preferably has a data link transceiver 28b and antenna 28c that enable emergency personnel to directly communicate with handsets having ID numbers that have been extracted and stored by the rescue-locator node 40, through an airborne node 20 without interfering with RF direction finding work. Like the data link transceiver station 28, 28a provided for the airborne node 20, this data link 28b, 28c also increases call handling capacity of the mobile rescue locator node 40, by enabling that node 40 to selectively delegate call handling to the airborne node 20 which may have better line-of-sight signal contact with the handsets, and can be used to transmit text and voice messages to large groups of diverse individual handsets whose ID numbers are known.

If local cellular infrastructure has not failed, the mobile nodes 20, 40, preferably passively receive the ID signals from which they extract the ID numbers that allow them to locate, track and communicate with handsets. However, when emergency circumstances require the mobile nodes 20, 40, to obtain ID numbers by initiating a response from handsets in a local area, a transceiver 22, 24, 42, 44 in the node 20, 40 transmits a beacon signal that includes a nominal node location ID identifying the mobile node 20, 40. This “nominal” location ID is selected to be distinct from location IDs that might be received by the same handsets from the local cellular infrastructure. Also, for a second beacon transmitted by a mobile node 20, 40, to reliably trigger a second transmission of an idle handset's ID signal, the mobile node's second beacon ID must have a different location ID and the second beacon must be a stronger signal than the most recent beacon signal received by the handset, or the idle handset's registration with that last beacon signal must have timed out, before a response can be triggered by the node's transmitting a second beacon.

Specifically, in the Radio Resources (RR) layer of conventional GSM cellular networks each GSM handset (MS) stores the location ID code of the last “primary” node, the Base Transceiver Station (BTS) that that MS registered with by transmitting its ID number in response to a beacon signal transmitted by that BTS. That “primary” BTS is the GSM BTS that had most recently had a stronger beacon signal than the last suitable beacon signal detected by the MS as it moves among the BTS nodes in the local cellular network. When a suitable beacon having a different location ID code is detected that is stronger than the signal currently received from the old primary BTS, the location ID code of that new primary BTS is then stored by the MS. The GSM MS registers itself to each new primary node by transmitting its own unique hardware ID number, without encryption, so that it can receive calls from the new primary node. In contrast, during a call, either the GSM Base Station Controller (BSC) or the GSM Mobile Switching Center (MSC) that controls all the BSCs in an area, coordinates the handover of an on-going call between two BTS nodes. In either instance, the hardware ID number that is transmitted by an idle MS can then be used by the new primary BTS to communicate with that MS. As a GSM MS's primary node, a mobile node 20, 40, can enable the handset to initiate and receive calls through the mobile node 20 and, acting in lieu of the local cellular network's MSC, the mobile node 20, 40, will now also control the use of encryption protocols in its voice and data communications with that GSM handset.

The infrastructure used by many 3G cellular handsets, GSM handsets in particular, provides Enhanced GPS (E-GPS). In E-GPS Enhanced Observed Time Difference (E-TOD) location data that includes: angle of arrival (AOA) or time difference (TDOA) triangulation, or multipath fingerprinting is used to enhance Global Positioning System (GPS) location data, and instead of that GPS location data in some non-GSM handsets. Location data is conventionally transmitted in response to an RR Location Services Protocol (RRLP) query from the handset's primary node, because the FCC requires that all cellular service providers in the United States be able to provide latitude and longitude data that is accurate to within 300 meters within six minutes of receiving a request from 9-1-1 emergency services operators by Sep. 11, 2012. However, after the local cellular network infrastructure fails, only handsets that are GPS-enabled can provide such handset location information.

Preferably, the protocol computer 26 automatically sends an RRLP GPS-coordinates query from the second transceiver 24 to each handset once the ID number of that handset has been stored by the protocol computer 26. The GPS coordinates transmitted in response to the RRLP query are then extracted, and stored by the emergency services node 20 with reference to the handset's ID number. The stored GPS location data for GPS-enabled cellular handsets can then be displayed by the protocol computer 20: 1) as a map with points that show the handsets' present or past locations, and/or 2) in a map of population density or traffic flow parameters, either as areas or as area boundaries, for example, or 3) as a map showing which cellular handsets have moved, or 4) as a map showing the direction and/or velocity and/or acceleration of handsets' movement over a given time period, in any of the many ways that are well-known in the art.

The communications and mapping operations done by the protocol computer 26 can be controlled directly by an operator who uses a workstation 30 carried by the aircraft 10, as noted above. Alternatively, the operator input device and the audio and video operator interfaces that control the protocol computer 26, 46 in the mobile cellular node 20, 40, may be provided remotely through conventional RF data link transceiver equipment installed on the aircraft itself 10 or in the mobile node 20, 40, itself. For example, because many PSTN networks have centralized power generation capacity that allows the legacy PSTN telephone infrastructure to operate off the electrical grid long after cellular telephone infrastructure fails from lack of electrical power, that airborne data link equipment 28, 28a, may be advantageous for “patching” the airborne node though a transceiver on the ground, such as the transceiver station 28b, 28c, shown in FIG. 3, into that local PSTN network and the PSTN long distance network. Like the ground based transceiver 28b, 28c, the airborne data link equipment 28, 28a, also enables another airborne node (not shown) to provide additional call handling capacity for that airborne node 20, if needed.

In accordance with the invention, just detecting and extracting ID signal data from the CMRS ID signal of a cellular handset, whether it is in the high-rise building or on a flood plain, enables rescue workers to track that handset. Extracting the ID number from that handset's CMRS ID signal enables the rescue workers to rapidly determine how the safety of people in its area can best be protected. Until now, without that cellular handset's telephone number, such an emergency call couldn't be made.

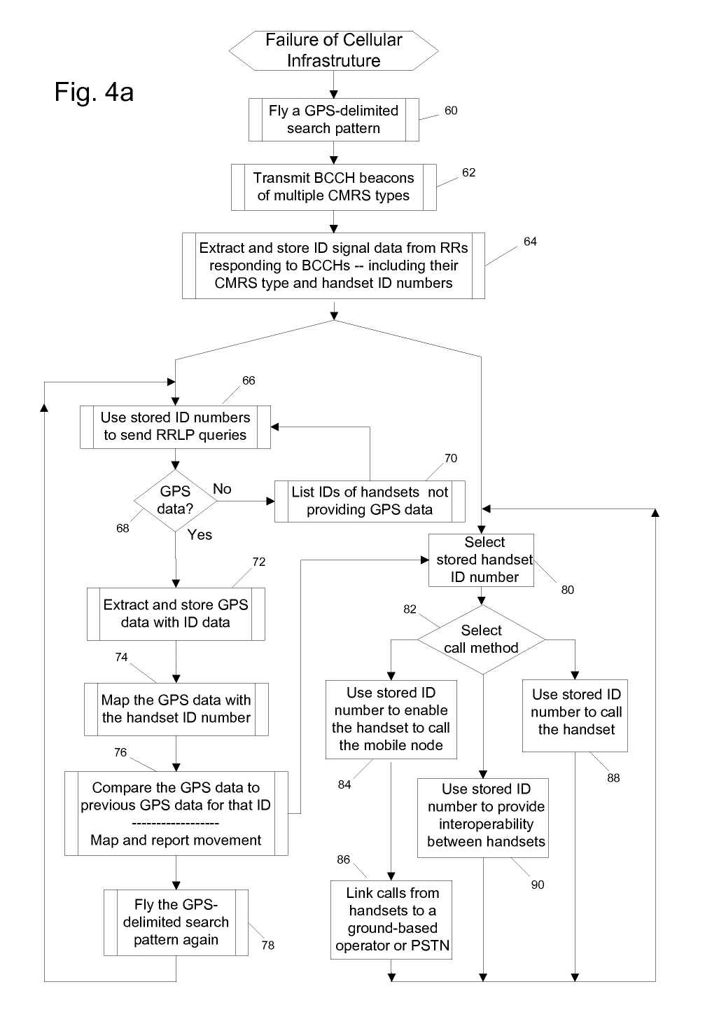

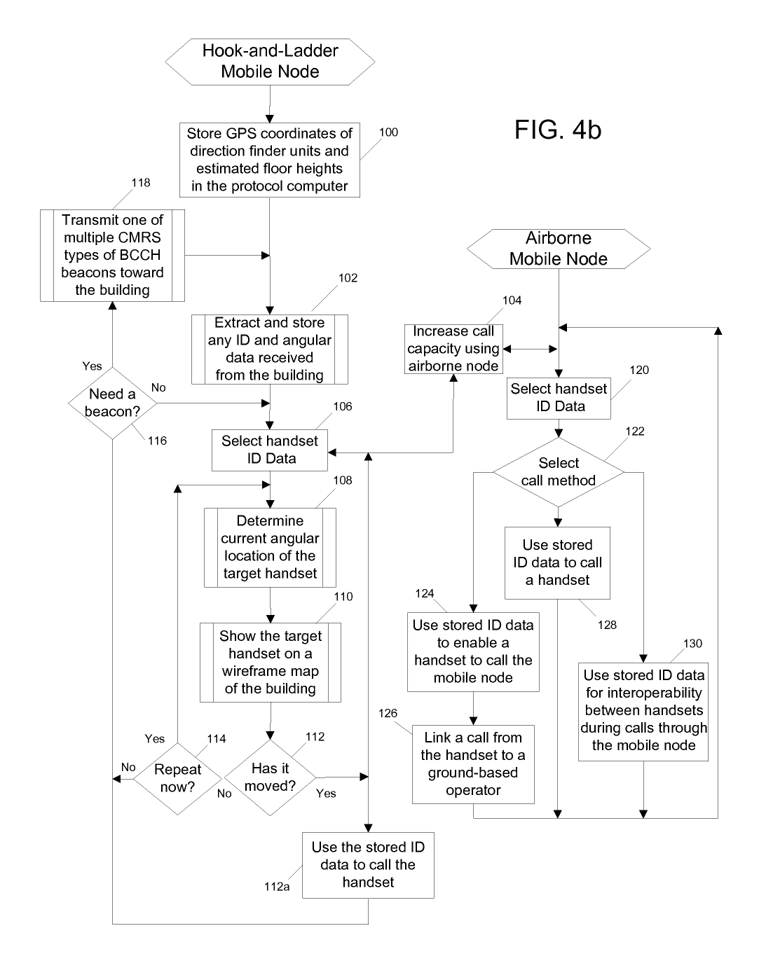

With reference to FIG. 4a, while an aircraft 10 carrying the airborne mobile node 20 flies a location-delimited search pattern 60 over a given area, it can extract and store any ID data transmitted by idle cellular handsets within its cone of coverage 14 as Resource Request (RR) registration.signals. The ID data is then stored 64 with search-pattern location data that indicates the point in the search pattern at which the respective ID data was received from a handset. Preferably, a GPS-delimited search pattern is flown and, once the handset's ID number is stored—the handset's IMEI, for example—the airborne node 20 can also obtain E-GPS and E-TOD location information from handsets in the cone of coverage 14 for non-emergency commercial services such as news reporting and transportation planning.

For example, an index of current traffic density and speed for all roads in the cone of coverage 14 can be determined from the movement of multiple cellular handsets that is detected and mapped by the node 20. However, after the local cellular infrastructure supporting a handset and its E-TOD data has failed in an emergency, not only is the E-TOD data no longer provided by that network, many handsets transmit the RR signal less often so as to conserve their battery power. Thus, in an emergency in which the local cellular infrastructure of a particular CMRS type has failed, the airborne node transmits its own BCCH beacon 62 having that particular signal format and frequency, and a location code that is different from those used by beacons of that CMES signal in that area, to force all the handsets within its cone of coverage 14 that rely on that failed infrastructure to respond the mobile node's BCCH beacon with their RR signals. This both increases the number ID numbers extracted from the signals received by the mobile node 20 each time it flies its search pattern 60, 78, and enables more of the handsets that rely on the failed cellular infrastructure to use the mobile node 20. To maximize the number of RR signals received in this instance, the location ID code included in the BCCH beacon will change each time the mobile node 20 transmits the BCCH beacon. The signal strength of the beacon that is detected by a handset will be increasing as the aircraft approaches the location of each handset.

Transmitting the type of BCCH beacon used by failed local cellular infrastructure allows the airborne node 20 to provide several advantageous functions in emergency situations: 1) Any of the cellular handsets having ID numbers extracted from their RR signals and stored by the mobile node 20 can be called 88 by an emergency operator located either in the air (FIG. 2) or on the ground (FIG. 3). 2) Signal level bars can be provided to selected handsets to enable cellular service subscribers dependent on the failed cellular infrastructure to originate a call 84 from their cellular handsets to an emergency operator or through the airborne mobile node 20 to the PSTN 86, for example. 3) Also, some point-to-point and conference calls can be set up by the multi-standard airborne node 20 among cellphones in the coverage area, regardless of the CMRS frequency and format used by those CMRS handsets. If some of those cellular handsets are also GPS-enabled: 4) The location and ID numbers of GPS-enabled handsets can be automatically mapped 74; and 5) movement of a GPS-enabled handset can be automatically detected and displayed on a map 76, as noted above, even after the cellular infrastructure fails. Handset movement will often be an indication that the handset has not been abandoned, which allows rescue workers to give priority to calling those handsets. In some emergency circumstances, the movement of a handset may even be interpreted as indicating that its user may be in danger, in which case immediate contact may be needed at that location.

To prevent call volume from blocking emergency workers' use of the airborne node 20, the well-known Priority Access System (PAS) may be implemented. Using PAS, government agencies can manage calling queues so that rescue workers have priority access to the airborne mobile node 20. The PAS algorithm allows a telephone network to exclude users who lack the authorization codes that have been given to rescue workers for use in major emergencies that overwhelm the local telephone networks. The altitude of the aircraft 10 may also be changed to reduce or increase the number of signals received by the node 20. In addition, a steerable directional antenna can be attached to hard points on the aircraft 10, and used to reduce such queuing problems by focusing on receiving signals transmitted from within particular parts of that area under the cone of coverage 14.

FIG. 4b shows a preferred method of operating a ground-based rescue locator node 40. Preferably the direction-finder units 42d-f of the rescue locator node 40 are all removably installed on mounting brackets that are all permanently affixed to a hook-and-ladder fire truck (not shown), or some other large emergency vehicle, at a known elevation above ground level. The two azimuth direction-finder units 42d-e of the rescue locator node 40 should be located at opposite ends of the truck to maximize resolution of the azimuth data. Once that truck is parked adjacent to a high-rise building where an emergency has occurred, the GPS coordinates of all three direction-finder units 42d-f are preferably automatically determined by the protocol computer 46, and the floor heights of the building are entered into it by the mobile node's operator, either as stated on the building's plans or by estimation 100, to calibrate the wireframe map that is used to represent the building. Simultaneously, the multi-modal direction-finder antennas 42d-f are directed toward the building to begin passively receiving any RR signals transmitted by idle handsets within the building, to extract and store the ID data for those handsets 102, along with the azimuth and elevation incidence angles of those signals that are detected by the direction finder 42a. Under the direction of the emergency workers, the locator-node operator then selects the ID numbers of target handsets near to the emergency area within the building 106 and uses their ID numbers to initiate a signal from the handsets that enables the node 40 to map 110 the three-dimensional location of each handset, monitor it for movement 112, 114, and also call any of the handsets 112a if necessary.

In a major emergency, contact between handsets in the building and the work of providing interoperability among emergency workers' RF communications gear is preferably delegated to an airborne node 104 to increase the call-handling capacity of the locator node 40. This can provide “ad hoc” interoperability 90 not only between CMRS handsets, but also between emergency services signal formats and frequencies and between the emergency workers' special-purpose communications gear and the cellular handsets of those awaiting rescue, without knowing any of the cellular handsets' telephone numbers and without regard to whether or not the supporting infrastructure for that handset has failed.

If the locator node 40 does not passively receive sufficient handset IDs 116, a highly directional transmission antenna 42b connected to the locator node 40 is directed toward the emergency area of the building. A single burst of a beacon having the frequency and format used by one of the cellular service providers that has the most subscribers in the area, but having a different location ID from those used by the local provider can then be transmitted 118 by that antenna 42b. To help resolve the ID data provided in the many RR signals that may be transmitted by idle handsets in response to that beacon, the hook- and ladder truck also preferably has an array of patch antennas 42c affixed to it that provide diversity reception in a manner that is well-known in the art. Once the ID number of a handset has been extracted and stored, that handset can be contacted individually to monitor its movement. In exceptional circumstances, to monitor movement of a target handset that does not have an ID number in its stored ID data, the target handset may be monitored by transmitting a special-purpose beacon having the CMRS frequency and format needed by that target handset. Preferably that special-purpose beacon will have a “nominal” location ID, as described above. The ID data extracted from all RR signals received in response to the special-purpose beacon can subsequently then be compared to the ID data that characterizes the RR signal of the target handset, to determine what angular location data has been stored for the target handset.

The invention has been described with particular reference to presently-preferred embodiments of the invention. However, it will be apparent to one skilled in the art the variations and modifications are possible within the spirit and scope of the invention. For example, the airborne node 20 and/or the ground-based rescue locator node 40 may be used to locate and communicate with lost hikers or with workers who are fighting wild fires in remote, rugged areas where there is little or no coverage by the conventional cellular telephone infrastructure. Alternatively, since prior knowledge of the telephone number of a cellular handset is not needed by these nodes 20, 40, the node may be combined with roadside cameras for use as a roadside traffic safety node by law enforcement. The traffic safety node can rapidly determine whether a moving handset has a call in progress. Once a moving handset that has a call in progress is detected and located, one or more cameras are triggered at the appropriate time to photographically record whether or not the driver of that car is illegally making that phone call while driving.

The invention is defined by the appended claims.

1. A mobile cellular node comprising:
a mobile Commercial Mobile Radio Services (CMRS) transceiver adapted to detect CMRS ID signals transmitted by idle CMRS handsets, said CMRS ID signals having any one of multiple signal types, said signal types having respective carrier frequencies and signal formats, said CMRS transceiver being adapted to extract ID signal data from said CMRS ID signals, said ID signal data being distinctive of the cellular handset that transmitted said ID signal; and
a protocol computer, said transceiver being connected to supply said ID signal data to said protocol computer, said protocol computer being adapted to store said ID signal data, said protocol computer being adapted to compare said ID signal data to ID signal data that was previously stored by said protocol computer so as to determine whether said cellular handset that transmitted said CMRS ID signal is the handset that transmitted another CMRS ID signal that included said ID signal data.

2. The mobile cellular node of claim 1, wherein said transceiver is adapted to supply data to said protocol computer indicating the CMRS signal type of the CMRS ID signal from which the ID signal data was extracted and said protocol computer is adapted to store data indicating the CMRS signal type of each ID signal from which ID signal data was extracted.

3. The mobile cellular node of claim 1, wherein said ID signal data includes an ID number, said protocol computer being adapted to use said ID number to initiate the transmission of a CMRS location query to said cellular handset by said transceiver and said transceiver being adapted to extract location data from a CMRS location signal transmitted by said cellular handset in response to said query that indicates the location of said handset.

4. The mobile cellular node of claim 3, wherein said protocol computer is adapted to store location data indicating the location of said handset and to map said stored location data.

5. The mobile cellular node of claim 4, wherein said protocol computer is adapted to detect and map changes in stored location data indicating the location of said handset over time.

6. The mobile cellular node of claim 1, wherein said ID signal data includes an ID number of the cellular handset, said protocol computer being adapted to use said ID number to initiate a call to said cellular handset.

7. The mobile cellular node of claim 1, wherein said ID signal data includes an ID number of the cellular handset, said protocol computer being adapted to use said ID number to enable said cellular handset to initiate a call.

8. The mobile cellular node of claim 1, wherein said ID signal data includes an ID number of a first cellular handset, further comprising:
a second mobile transceiver, said second transceiver being adapted to send signals to and receive signals from a second handset using a signal type that is different from the signal type of said first cellular handset,
said protocol computer being adapted to use said ID number extracted by the first mobile CMRS transceiver to provide interoperability for said first cellular handset by enabling said first cellular handset to initiate a call through said second mobile transceiver to said second cellular handset.

9. The mobile cellular node of claim 1, further comprising a direction finder in said mobile CMRS transceiver, said direction finder detecting CMRS signals and determining elevation data for said CMRS signals, said CMRS signals including said CMRS ID signals having ID signal data, said CMRS transceiver supplying said elevation data to said protocol computer for said CMRS ID signals.

10. The mobile cellular node of claim 1 further comprising an RF data link connected to said protocol computer, said protocol computer being adapted to increase the call handling capacity of the mobile cellular node by delegating calls initiated by said protocol computer to an airborne mobile cellular node using said RF data link.

11. A method for operating a mobile cellular node, comprising the steps of:
detecting Commercial Mobile Radio Services (CMRS) ID signals using the mobile cellular node, said CMRS ID signals being signals transmitted by cellular handsets and having any one of multiple CMRS signal types detected by the mobile cellular node, said signal types having respective carrier frequencies and signal formats;
extracting ID signal data from one of said detected CMRS ID signals received by the mobile cellular node, said ID signal data being distinctive of the cellular handset that transmitted said CMRS ID signal; and
comparing said ID signal data to ID signal data stored by said mobile node so as to determine whether said cellular handset that transmitted said CMRS ID signal is a handset that transmitted another CMRS signal having stored ID signal data.

12. The method of claim 11 further comprising the step steps of:
determining the CMRS signal type of the CMRS ID signal from which the ID signal data was extracted;
storing data indicating the CMRS signal type of the CMRS ID signal from which said ID signal data was extracted.

13. The method of claim 11 wherein said ID signal data includes a handset ID number and further comprising the step of using the handset ID number to initiate a call to the handset.

14. The method of claim 11 wherein said ID signal data includes a handset ID number and further comprising the step of using the handset ID number to enable the cellular handset to initiate a call.

15. The method of claim 11 wherein said ID signal data includes a handset ID number and further comprising the step of using the handset ID number to provide interoperability for a first handset by enabling said handset to initiate a call through the mobile node to a second handset having a different signal type

16. The method of claim 11 further comprising the steps of:
transmitting a first beacon signal having a first nominal location ID and
transmitting a second beacon signal having a second nominal location ID that is different from the first nominal location ID.

17. The method of claim 11 wherein the node is carried by an aircraft, said method further comprising the steps of:
flying a location-data defined search pattern; and
storing ID location data for the ID signal data that is stored for each handset during each iteration of the search pattern, said ID location data indicating where the aircraft was in the search pattern when the mobile node received the ID signal data from the respective handset.

18. The method of claim 11 wherein said stored ID signal data includes a handset ID number, further comprising the steps of:
transmitting a location query to said cellular handset using the handset ID number; and
extracting handset location data from a location signal transmitted by said cellular handset in response to said location query.

19. The method of claim 11 wherein the node has a three-dimensional RF direction finder having azimuth direction-finder units, said method further comprising the steps of:
determining data indicating the elevation of a handset having a given CMRS ID signal using the RF direction finder.

20. The method of claim 11 said method further comprising the steps of:
obtaining handset location data for a cellular handset by using the handset's CMRS ID signal; and
mapping the handset location data obtained for said cellular handset.

21. The method of claim 11 further comprising the steps of:
obtaining handset location data for a cellular handset by using the handset's CMRS ID signal, said handset location data indicating the location of a vehicle having a driver; and
photographing the driver of the vehicle at that location when that location signal was sent by the cellular handset.
